(19) United States
(12) Patent Application Publication
(10) Pub. No.: US 2005/0044901 A1
(43) Pub. Date: Mar. 3, 2005

(54) Padlock

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/725,549

(22) Filed: Dec. 3, 2003

(30) Foreign Application Priority Data
Aug. 25, 2003 (TW) 92215392

(51) Int. Cl. E05B 37/02

(52) U.S. Cl. 70/25; 70/284; 70/285

(57) ABSTRACT

A padlock that can be unlocked by the owner of the padlock by dialing an unlocking number or by authorized security personals with a general key. The padlock mainly contains a lock body, a shackle, a private locking means and a general locking means. The lock body has a first chamber and a second chamber therein. The lock body has a receptacle thereon and a hole communicable to the first chamber. The shackle has a longer arm and shorter arm. The longer arm is slidably received in the first chamber through the hole of the lock body. The longer arm has a stop at an end thereof and the shorter arm is engagable with the receptacle of the block. The private locking means is formed in the first chamber. The private locking means contains a frame and mechanism. The frame has a sliding space therein. The frame has a first opening on top thereof for receiving the end and the stop of the longer arm in the sliding space. The mechanism is used for controlling movements of the frame. The frame is movable between the mechanism and the hole of the lock body. The general locking means is installed in the second chamber for controlling movements of the end and the stop of sad longer arm.

### TECHNICAL FIELD

This invention relates generally to a padlock, in particular, to provide a padlock having a shackle locked by a key operated locking means at one end and a combination locking means at another end, thereby the padlock can be unlocked by using a key or by dialing the combination locking means to an unlocking number.

### BACKGROUND OF THE INVENTION

Preventing personal stuffs from being lost or stolen, travelers usually lock their own travel baggage boxes. Combination lock is the most common lock that installed in a travel baggage box because it takes little space. Each traveler sets up his own security number for the combination lock. Thereby others without knowing the security number cannot unlock his baggage box. However terrorists may use travel baggage boxes to deliver explosive devices to endanger people's safety. Security personals in airports may need to exam travelers' travel baggage boxes in some circumstances without presence of the owners of the travel baggage boxes. Some countries require travelers not to lock their travel baggage boxes. The travelers may lose their properties in their travel baggage boxes if they leave their travel baggage boxes unlocked. If they choose to lock their baggage boxes, the security personals are authorized to damage the travel baggage boxes in order to exam objects inside of the travel baggage boxes. There is a dilemma between travelers' rights and flight safety. Therefore, a padlock that can protect travels' properties and allow security personals to unlock the padlock is needed.

### SUMMARY OF INVENTION

It is therefore an objective of the present invention to provide a padlock that can be unlocked by the owner of the padlock by dialing an unlocking number or by authorized security personals with a general key.

The present invention, briefly summarized, in one embodiment discloses a padlock. The padlock mainly contains a lock body, a shackle, a private locking means and a general locking means. The lock body has a first chamber and a second chamber therein. The lock body has a receptacle thereon and a hole communicable to the first chamber. The shackle has a longer arm and shorter arm. The longer arm is slidably received in the first chamber through the hole of the lock body. The longer arm has a stop at an end thereof and the shorter arm is engagable with the receptacle of the block. The private locking means is formed in the first chamber. The private locking means contains a frame and mechanism. The frame has a sliding space therein. The frame has a first opening on top thereof for receiving the end and the stop of the longer arm in the sliding space. The mechanism is used for controlling movements of the frame. The frame is movable between the mechanism and the hole of the lock body. The general locking means is installed in the second chamber for controlling movements of the end and the stop of sad longer arm.

### BRIEF DESCRIPTION OF DRAWINGS

The invention will be more clearly understood after referring to the following detailed description read in conjunction with the drawings wherein:

FIG. 1 is an exploded view of the first embodiment of present invention;

FIG. 2 is a cross sectional view of the locked first embodiment;

FIG. 3 is a cross sectional view of the first embodiment demonstrating the engaging element engaged with the stop;

FIG. 4 is a cross sectional view of the first embodiment unlocked through rotating the number wheels of the combination locking means;

FIG. 5 is a cross sectional view of the first embodiment unlocked through operating the key operated locking means;

FIG. 6 is a cross sectional view of the first embodiment demonstrating the engaging element disengaged with the stop;

FIG. 7 is a perspective view of the key operated locking means of the second embodiment;

FIG. 8 is a cross sectional view of the locked second embodiment;

FIG. 9 is a cross sectional view of the second embodiment demonstrating the engaging element engaged with the stop;

FIG. 10 is a cross sectional view of the second embodiment unlocked through rotating the number wheels of the combination locking means;

FIG. 11 is a cross sectional view of the second embodiment unlocked through operating the key operated locking means;

FIG. 12 is a cross sectional view of the second embodiment demonstrating the engaging element disengaged with the stop;

FIG. 13 is a cross sectional view of the locked third embodiment demonstrating the stop is engaged with the lower bend of the spring plate of the frame;

FIG. 14 is a cross sectional view of the third embodiment demonstrating the engaging element engaged with the stop;

FIG. 15 is a cross sectional view of the third embodiment unlocked through rotating the number wheels of the combination locking means;

FIG. 16 is a cross sectional view of the third embodiment unlocked through operating the key operated locking means;

FIG. 17 is a cross sectional view of the third embodiment demonstrating the engaging element disengaged with the stop;

FIG. 18 is a cross sectional view of the locked fourth embodiment;

FIG. 19 is a cross sectional view of the fourth embodiment demonstrating the engaging protrusion of the first block engaged with the hemi-cylinder of the key operated locking means;

FIG. 20 is a cross sectional view of the fourth embodiment unlocked through rotating the number wheels of the combination locking means;

FIG. 21 is a cross sectional view of the fourth embodiment unlocked through operating the key operated locking means;

FIG. 22 is a cross sectional view of the fourth embodiment demonstrating the hemi-cylinder of the key operated locking means is rotated to eject the engaging protrusion of the first block.

FIG. 23 is a cross sectional view of the locked fifth embodiment;

FIG. 24 is a cross sectional view of the fifth embodiment demonstrating the hemi-cylinder of the key operated locking means engaged with the bottom of the tongue;

FIG. 25 is a cross sectional view of the fifth embodiment unlocked through rotating the number wheels of the combination locking means;

FIG. 26 is a cross sectional view of the fifth embodiment unlocked through operating the key operated locking means; and

FIG. 27 is a cross sectional view of the fifth embodiment demonstrating the hemi-cylinder of the key operated locking means disengaged with the bottom of the tongue.

### DETAILED DESCRIPTION OF PREFERRED EMBODIMENTS

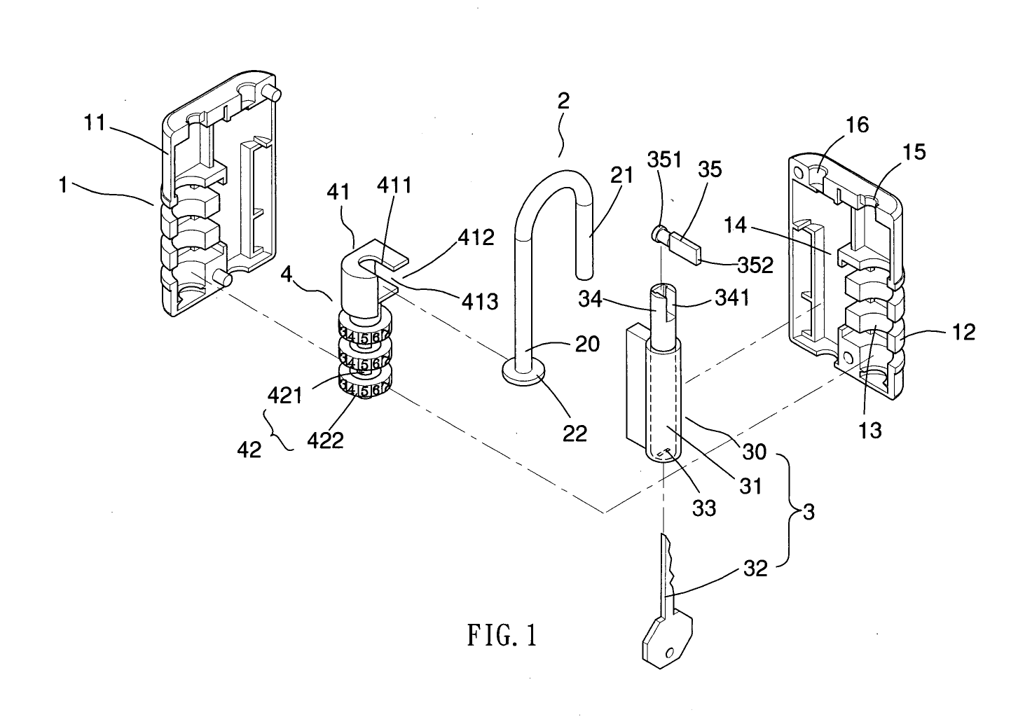

With reference to FIG. 1 to FIG. 6, the padlock of the first embodiment of the present invention mainly contains a lock body 1, a shackle 2, a private locking means 4 and a general locking means 3. The lock body 1 contains a front cover 11 and a back cover 12 engaged with the front cover 11. The lock body 1 has a first chamber 13 and a second chamber 14 therein. The lock body 1 has a receptacle 16 thereon and a hole 15 communicable to the first chamber 13. The shackle 2 has a longer arm 20 and shorter arm 21. The longer arm 20 is slidably received in the first chamber 13 through the hole 15 of the lock body 1. The longer arm 20 has a stop 22 at an end thereof and the shorter arm 21 is engagable with the receptacle 16 of the lock body 1. The private locking means 4 is formed in the first chamber 13. The private locking means 4 contains a frame 41 and mechanism 42. The frame 41 has a sliding space 413 therein. The frame 41 has a first opening 411 on top thereof for receiving the end and the stop 22 of the longer arm 20 in the sliding space 413. The mechanism 42 is used for controlling movements of the frame 41. The frame 41 is movable between the top of the mechanism 42 and a bottom of the hole 15 of the lock body 1. The general locking means 3 is installed in the second chamber 14 for controlling movements of the end and the stop 22 of sad longer arm 20.

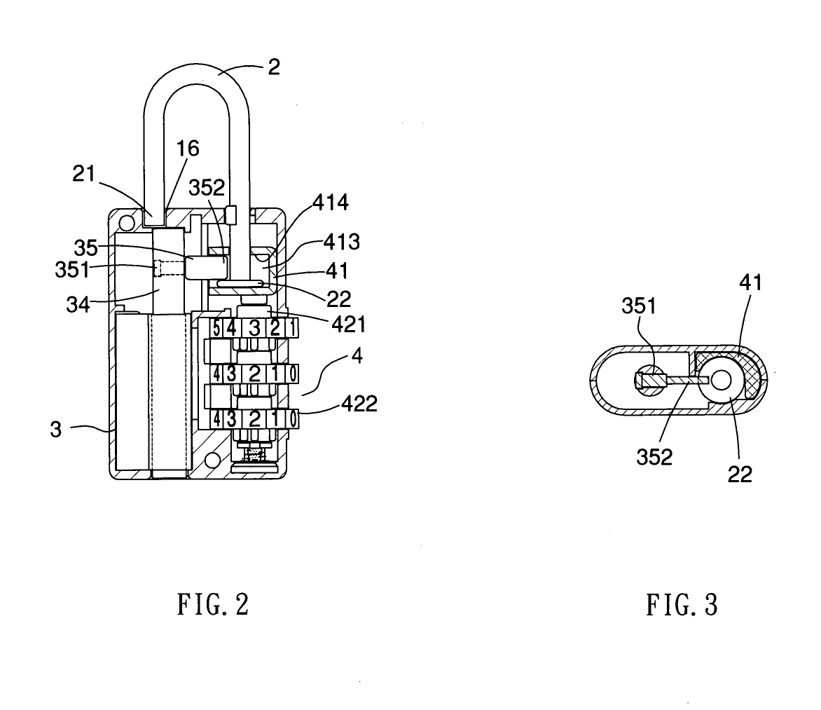

The general locking means 3 contains: a body 30 having a rotor 31 received therein and a driving rod 34 extended from the rotor 31. The rotor 31 has a keyhole 33 at a bottom end thereof for being engaged with a key 32. The driving rod 34 has a slot 341 therein, and an engaging element 35 having one end 351 slidably received in the slot 341. With reference to FIG. 1 and FIG. 2, the other end 352 of the engaging element 35 can be rotated by the key 32 through a second opening 412 of the frame 41 to a position between a inner top 414 of the frame 41 and the stop 22 to block movements of the stop 22 within the sliding space 413. The mechanism 42 of the private locking means 4 contains a stem 421 connected to the frame 41 and plural number wheels 422 rotatably mounted around the stem 421 for controlling vertical movement of the frame 41.

Referring to FIG. 2 and FIG. 3, the padlock of the first embodiment is locked. The general locking means 3 is not operated, so the end 352 of the engaging element 35 is placed between the inner top 414 of the frame 41 and the stop 22 to block the movement of the stop 22. Because the number wheels 422 are not dialed to the unlocking number, the stem 421 and the frame 41 connected thereto cannot move vertically. The frame 41 is positioned at the lowest point of its movement and the shorter arm 21 of the shackle 2 is placed within the receptacle 16.

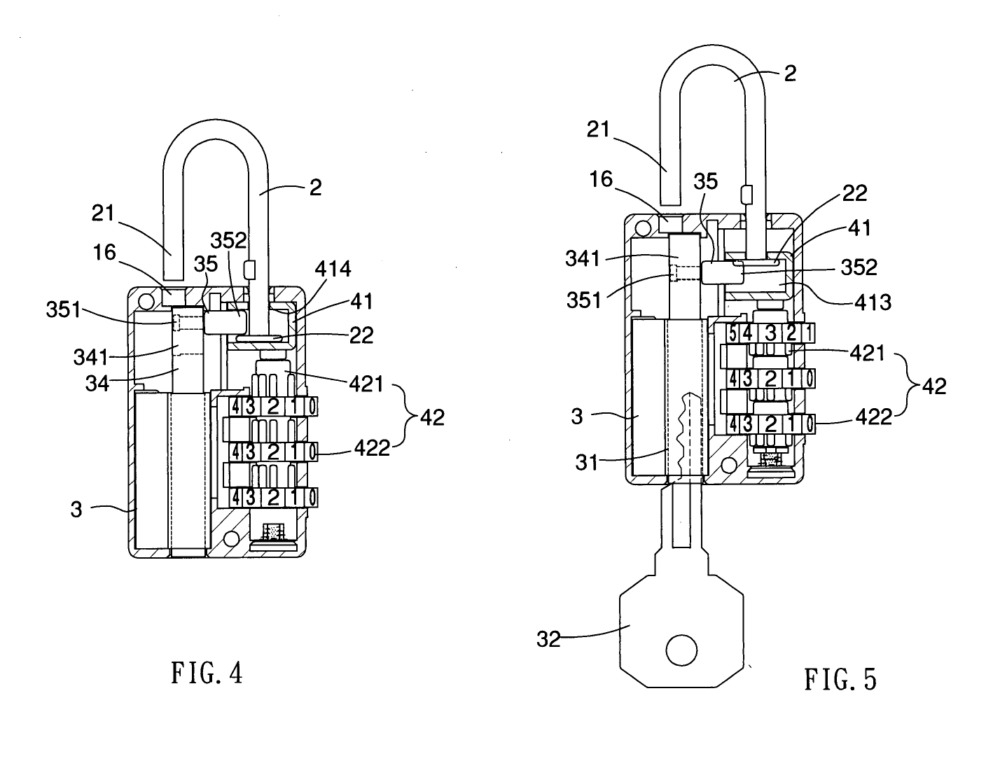

With reference to FIG. 4, the padlock of the first embodiment is unlocked by dialing the number wheels 422 to the unlocking number. Since the number wheels 422 of the private locking means 4 are dialed to the unlocking number and the end 351 of the engaging element 35 is slidably received in the slot 341 of the driving rod 34, the frame 41 connected to the stem 421 can move vertically to the highest point of its movement. The stop 22 moves together with the frame 41 and the shackle 2 and the shorter arm 21 moves synchronously. Thereby the shorter arm 21 of shackle 2 is removed from the receptacle 16 and the padlock is unlocked.

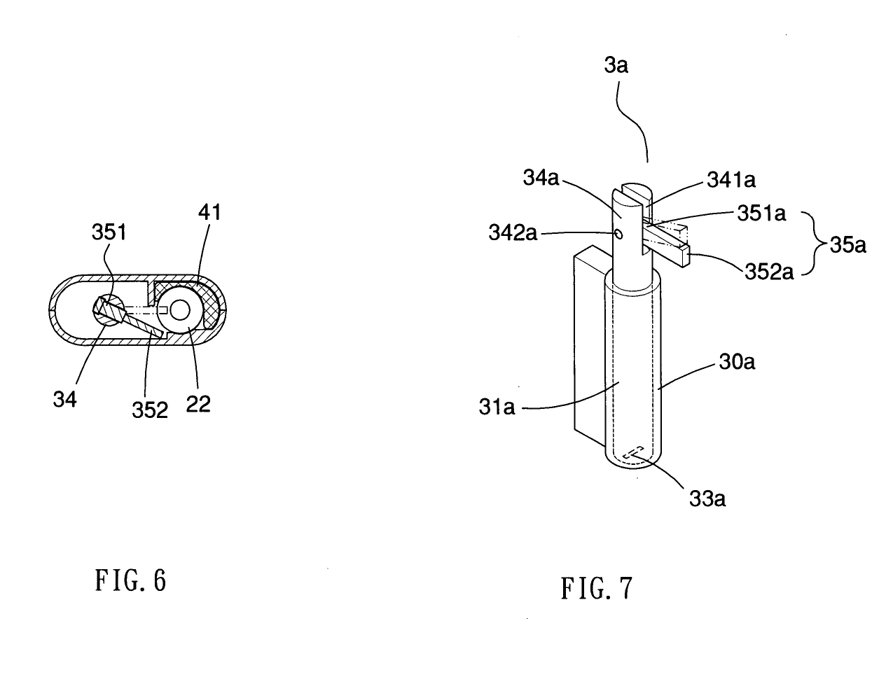

With reference to FIG. 5 and FIG. 6, the padlock of the first embodiment is unlocked by operating the general locking means 3. The key 32 is rotated to an unlocked position and the engaging element 35 together with the driving rod 34 is rotated synchronously. The end 352 of the engaging element 35 then is rotated to disengaged with the stop 22 as shown in FIG. 6. Thereby, the stop 22 can move vertically within the sliding space 413 of the frame 41 and the shorter arm 21 of the shackle 2 is removed from the receptacle 16.

With reference to FIG. 7 to FIG. 12, the padlock of the second embodiment of the present invention has the same structure as the padlock of the first embodiment except the general locking means 3. As shown in FIG. 7, the general locking means 3 of the second embodiment is a key operated locking means 3a. The key operated locking means 3a contains: a body 30a having a rotor 31a received therein and a driving rod 34a extended from the rotor 31a. The rotor 31a has a keyhole 33a at a bottom end thereof for being engaged with a key. The driving rod 34a has a slot 341a therein, and an engaging element 35a having one end 351a pivotally connected to a pivot 342a in the slot 341a.

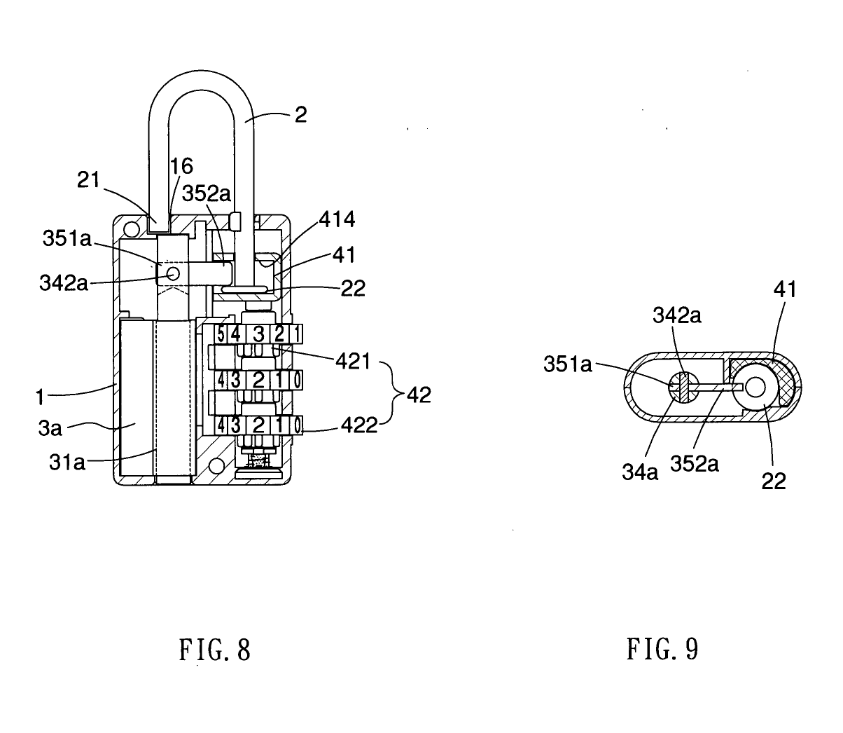

Referring to FIG. 8 and FIG. 9, the padlock of the second embodiment is locked. The key operated locking means 3a is not operated, so the end 352a of the engaging element 35a is placed between the inner top 414 of the frame 41 and the stop 22 to block the movement of the stop 22. Because the number wheels 422 are not dialed to the unlocking number, the stem 421 and the frame 41 connected thereto cannot move vertically. The frame 41 is positioned at the lowest point of its movement and the shorter arm 21 of the shackle 2 is placed within the receptacle 16.

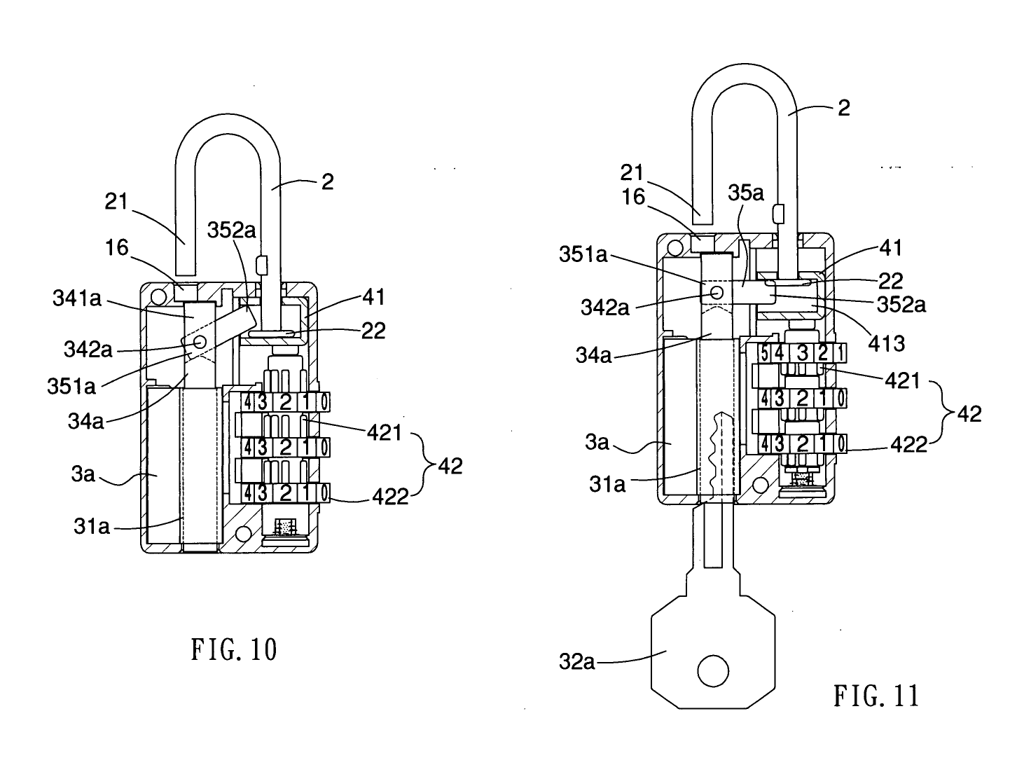

With reference to and FIG. 10, the padlock of the second embodiment is unlocked by dialing the number wheels 422 to the unlocking number. Since the number wheels 422 of the combination locking means 4 are dialed to the unlocking number and the end 351a of the engaging element 35a is pivotally connected to a pivot 342a in the slot 341a of the driving rod 34a, the frame 41 connected to the stem 421 can move vertically to the highest point of its movement. The stop 22 moves together with the frame 41 and the shackle 2 and the shorter arm 21 moves synchronously. Thereby the shorter arm 21 of shackle 2 is removed from the receptacle 16 and the padlock is unlocked.

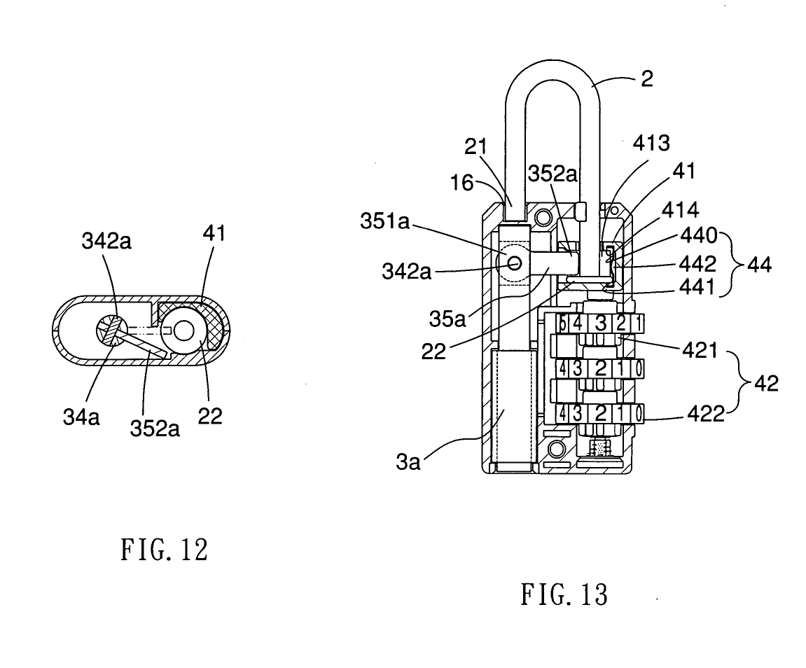

With reference to FIG. 11 and FIG. 12, the padlock of the second embodiment is unlocked by operating the key operated locking means 3a. The key 32a is rotated to an unlocked position and the engaging element 35a together with the driving rod 34a is rotated synchronously. The end 352a of the engaging element 35a then is rotated to disengaged with the stop 22 as shown in FIG. 12. Thereby, the stop 22 can move vertically within the sliding space 413 of the frame 41 and the shorter arm 21 of the shackle 2 is removed from the receptacle 16.

With reference to FIG. 13 to FIG. 17, the padlock of the third embodiment of the present invention has the same structure as the padlock of the second embodiment except the third embodiment further contains a spring plate 44. The spring plate 44 has two bends 440, 441 at upper and lower portion thereof and a swelling 442 between the two bends 440, 441. The spring plate 44 is mounted in the frame 41. The two bends 440, 441 are for securely holding the stop 22. Thereby when the stop 22 slides in the sliding space 413, it always locates at top or bottom of the sliding space 413 not something between.

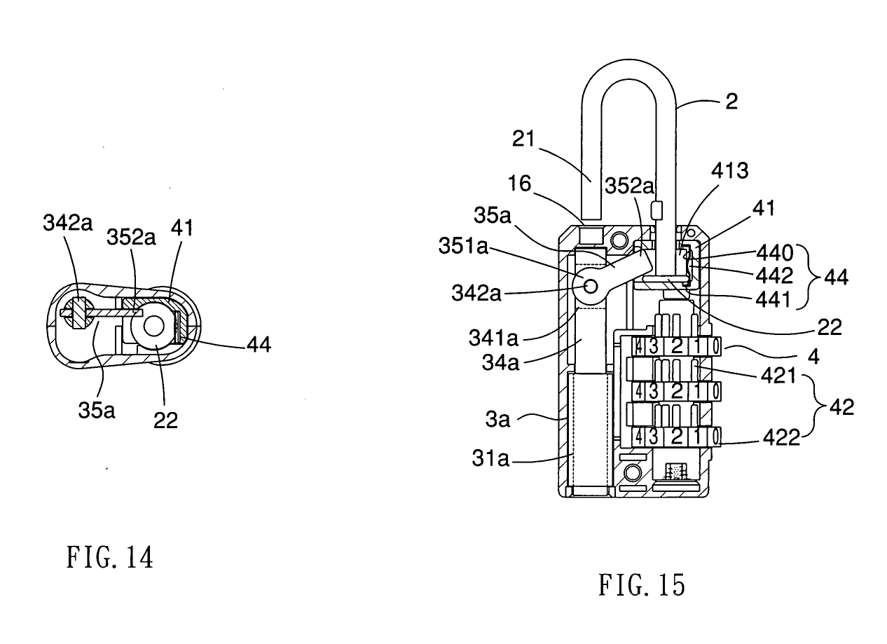

Referring to FIG. 13 and FIG. 14, the padlock of the third embodiment is locked.

The key operated locking means 3a is not operated, so the end 352a of the engaging element 35a is placed between the inner top 414 of the frame 41 and the stop 22 to block the movement of the stop 22. The stop 22 is holding in the lower bend 441 of the spring plate 44. Because the number wheels 422 are not dialed to the unlocking number, the stem 421 and the frame 41 connected thereto cannot move vertically. The frame 41 is positioned at the lowest point of its movement and the shorter arm 21 of the shackle 2 is placed within the receptacle 16.

With reference to FIG. 15, the padlock of the third embodiment is unlocked by dialing the number wheels 422 to the unlocking number. Since the number wheels 422 of the combination locking means 4 are dialed to the unlocking number and the end 351a of the engaging element 35a is pivotally connected to a pivot 342a in the slot 341a of the driving rod 34a, the frame 41 connected to the stem 421 can move vertically to the highest point of its movement. The stop 22 holding in the lower bend 441 moves together with the frame 41 and the shackle 2 and the shorter arm 21 moves synchronously. Thereby the shorter arm 21 of shackle 2 is removed from the receptacle 16 and the padlock is unlocked.

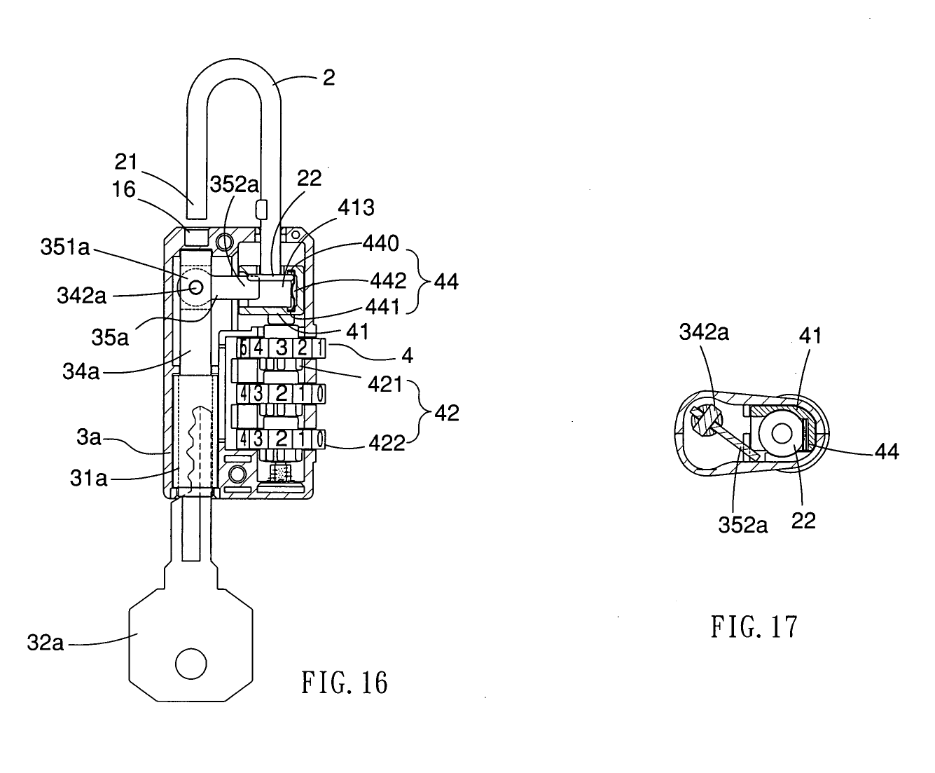

With reference to FIG. 16 and FIG. 17, the padlock of the third embodiment is unlocked by operating the key operated locking means 3a. The key 32a is rotated to an unlocked position and the engaging element 35a together with the driving rod 34a is rotated synchronously. The end 352a of the engaging element 35a then is rotated to disengaged with the stop 22 as shown in FIG. 17. Thereby, the stop 22 can move vertically within the sliding space 413 of the frame 41 and the shorter arm 21 of the shackle 2 is removed from the receptacle 16. The stop 22 is always located either in the upper bend 440 or the lower bend 441 of the spring plate 44 and the movements of the stop 22 are thereby steady.

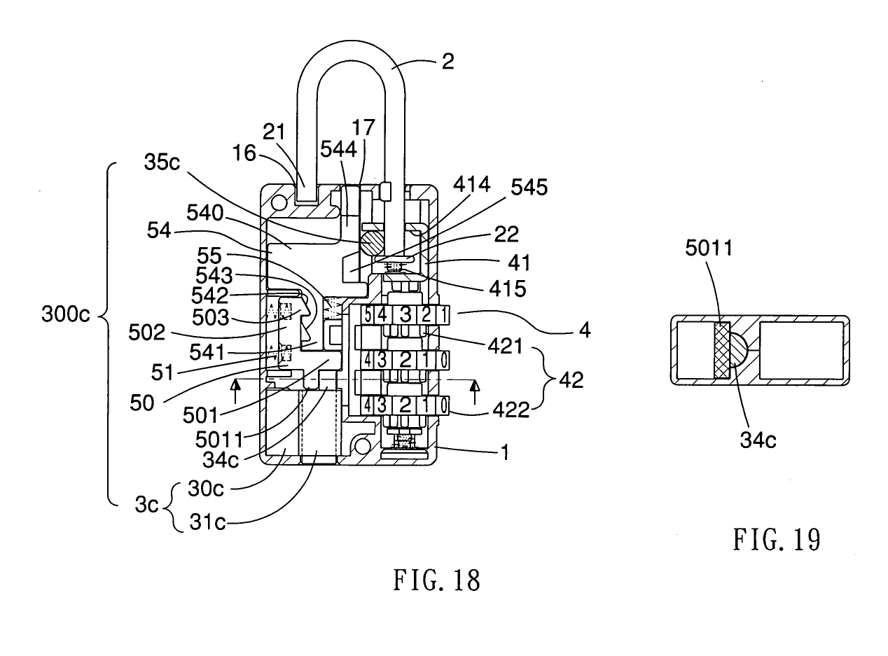

With reference to FIG. 18 to FIG. 22, the padlock of the fourth embodiment of the present invention has the same structure as the padlock of the first embodiment except the general locking means 3 and the fourth embodiment further contains a spring 415 located between the stop 22 and an inner bottom of the frame 41. The general locking means 300c of the fourth embodiment contains: a ball 35c, a first block 50, at least one restoring spring 51, a second block 54 and a key operated locking means 3c. The first block 50 contains: a horizontal beam 501 having an engaging protrusion 5011 thereon; and a vertical beam 502 extended from an end of the horizontal beam 501. The vertical beam 502 has a hook 503 at an end thereof At least one restoring spring 51 is engaged with the vertical beam 502 of the first block 50. The second block 54 contains: a block body 540, a first rod 541, a guiding rod 544, and a compress spring 55. The block body 540 has a depression 545 therein for receiving the ball 35c. The first rod 541 is extended from the block body 540. The first rod 541 has two teeth 542, 543 thereon engagable with the hook 503 of the vertical beam 502. The guiding rod 544 is extended from the block body 540. The guiding rod 544 is engagable with a guiding channel 17 of the lock body 1. The compress spring 55 is engaged with a bottom of the block body 540. The key operated locking means 3c contains: a body 30c having a rotor 31c received therein and a hemi-cylinder 34c extended. from the rotor 31c. The rotor 31c has a keyhole 33c at a bottom end thereof for being engaged with a key 32c. The hemi-cylinder 34c is engaged with the engaging protrusion 5011 of the horizontal beam 501 of the first block 50.

Referring to FIG. 18 and FIG. 19, the padlock of the fourth embodiment is locked. The flat surface of the hemi-cylinder 34c is overlaid to one side of the engaging protrusion 5011 and restoring spring 51 are not pressed. The hook 503 is engaged with the upper teeth 542 of the first rod 541, so the ball 35c is placed between the inner top 414 of the frame 41 and the stop 22 to block the movement of the stop 22. A side of the guiding rod 544 is against one edge of the ball 35c from preventing the ball 35c fall out of the frame 41. Because the number wheels 422 are not dialed to the unlocking number, the stem 421 and the frame 41 connected thereto cannot move vertically. The frame 41 is positioned at the lowest point of its movement and the shorter arm 21 of the shackle 2 is placed within the receptacle 16.

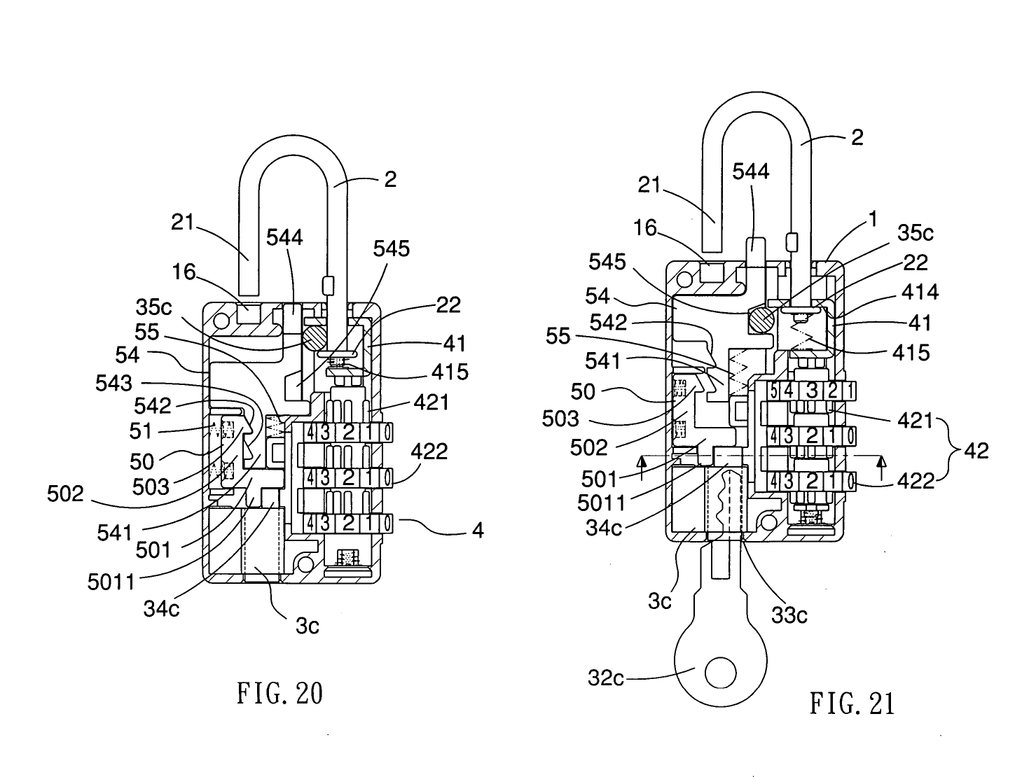

Referring to FIG. 20, the padlock of the fourth embodiment is unlocked by dialing the number wheels 422 to the unlocking number. Since the number wheels 422 of the combination locking means 4 are dialed to the unlocking number, the frame 41 connected to the stem 421 can move vertically to the highest point of its movement. The stop 22 and the ball 35c move together with the frame 41 and the shackle 2 and the shorter arm 21 moves synchronously. Thereby the shorter arm 21 of shackle 2 is removed from the receptacle 16 and the padlock is unlocked.

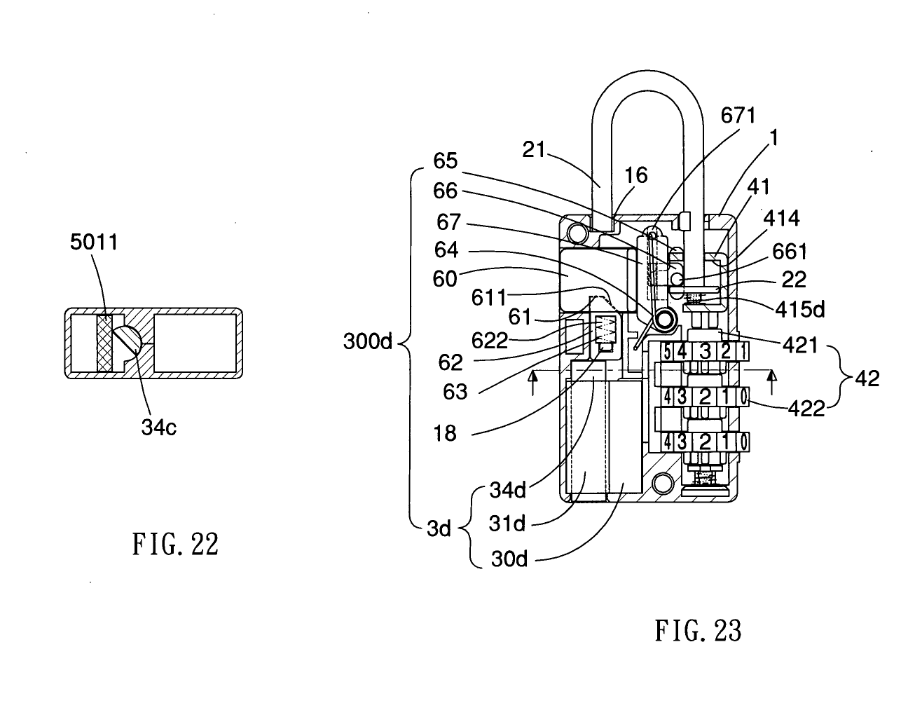

Referring to FIG. 21 and FIG. 22, the padlock of the fourth embodiment is unlocked by operating the key operated locking means 3c. When the key 32c is rotated to an unlocked position, the hemi-cylinder 34c reject the engaging protrusion 5011 away with its edge as in FIG. 22. Thereby the first block 50 moves left and the hook 503 is disengaged from the upper teeth 542 and the compress spring 55 reject the second block 54 upwardly to its highest position that the side of the guiding rod 544 is no longer against the edge of the ball 35c and the ball 35c falls into the depression 545 of the second block 54. Therefore the stop 22 is rejected by the spring 415 in the frame 41 upwardly and the shorter arm 21 of the shackle 2 is removed from the receptacle 16. The guiding rod 544 is extended out of the lock body 1 as shown in FIG. 21. To restore the padlock of the fourth embodiment, pushing the out extended portion of the guiding rod 544 and the shackle 2 so the ball 35c is placed between the inner top 414 of the frame 41 and the stop 22 again.

With reference to FIG. 23 to FIG. 27, the padlock of the fifth embodiment of the present invention has the same structure as the padlock of the first embodiment except the general locking means 3 and the fifth embodiment further contains a spring 415d located between the stop 22 and an inner bottom of the frame 41. The general locking means 300d of the fifth embodiment contains: a moving block 60, a driving bar 67, a sliding element 66, a spiral spring 64, a sliding track 65, a tongue 62, a lever 18, a spring 63 and a key operated means 3d. The moving block 60 has a recess 61 with an inclined surface 611 at bottom thereof. The driving bar 67 has a sliding channel 671 therein. The driving bar 67 is engaged to driving the moving block 60. The sliding element 66 has a cylinder 661 thereon. The sliding element 66 is slidably received in the sliding channel 671 of the driving bar 67. The sliding track 65 is formed in the lock body 1. The sliding track 65 has a main track 651 and a branch track 652 extended from middle of the main track 651. The spiral spring 64 is engaged with the driving bar 67 for driving the moving block 60.

The tongue 62 has an inclined surface 621 engagable with the inclined surface 611 of the recess 61 of the moving block 60. The tongue 62 has a room 622 therein. The lever 18 is mounted in the lock body 1. The spring 63 is installed with one end against a top surface of the room 622 of the tongue 62 and with another end against the lever 18. The key operated locking means 3d contains a body 30d having a rotor 31d received therein and a hemi-cylinder 34d extended from the rotor 31d. The rotor 31d has a keyhole 33d at a bottom end thereof for being engaged with a key 32d. The hemi-cylinder 34d is engaged with a bottom of the tongue 62.

Referring to FIG. 23, the padlock of the fifth embodiment is locked. The sliding element 66 is placed between the inner top 414 of the frame 41 and the stop 22 to block the movement of the stop 22. Because the number wheels 422 are not dialed to the unlocking number, the stem 421 and the frame 41 connected thereto cannot move vertically. The frame 41 is positioned at the lowest point of its movement and the shorter arm 21 of the shackle 2 is placed within the receptacle 16.

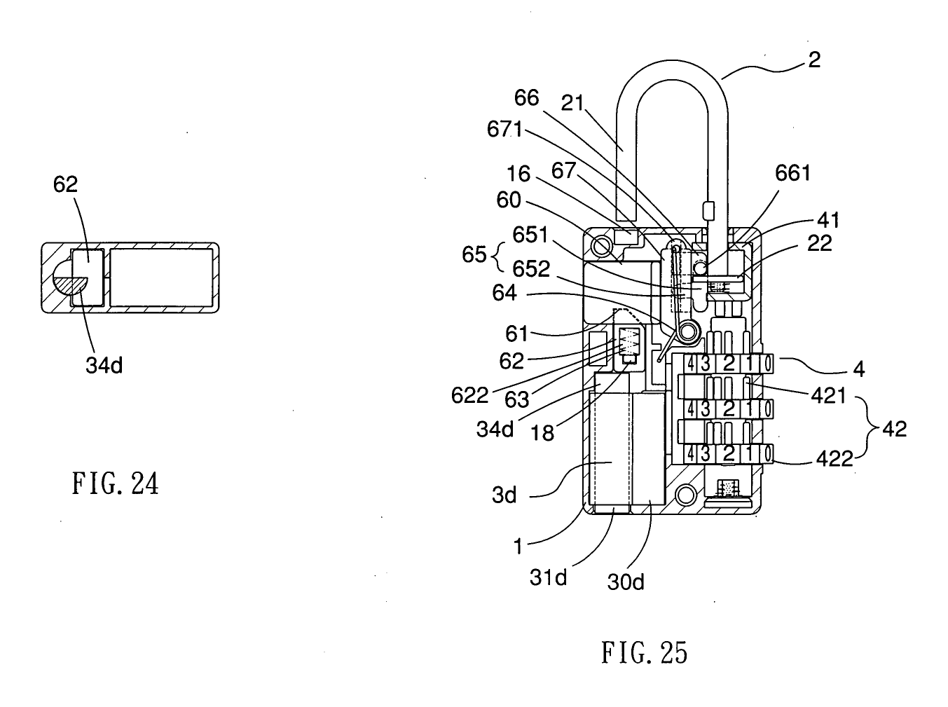

With reference to FIG. 24 and FIG. 25, the padlock of the fifth embodiment is unlocked by dialing the number wheels 422 to the unlocking number. Since the number wheels 422 of the combination locking means 4 are dialed to the unlocking number and the sliding element 66 can slid vertically in the sliding channel 671 of the driving bar 67 and the cylinder 661 of the sliding element 66 slides vertically along the main track 651, the frame 41 connected to the stem 421 can move vertically to the highest point of its movement. The shackle 2 and the shorter arm 21 moves synchronously with the stop 22. Thereby the shorter arm 21 of shackle 2 is removed from the receptacle 16 and the padlock is unlocked. As shown in FIG. 24, the hemi-cylinder 34d supports the bottom of the tongue 62 thereby the tongue 62 is engaged with the recess 61 to prevent the moving block 60 from moving.

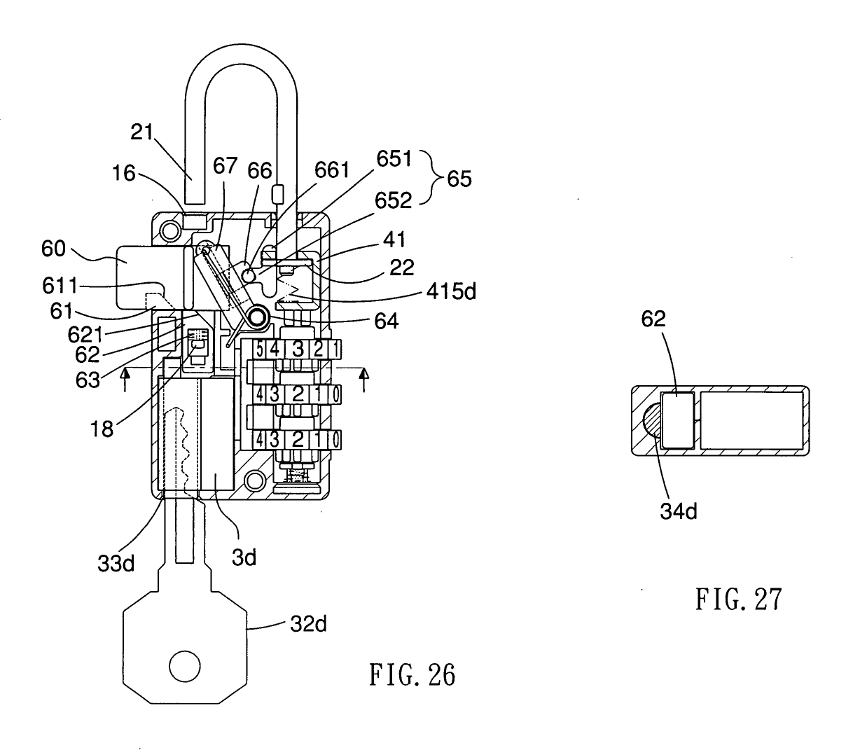

With reference to FIG. 26 and FIG. 27, the padlock of the fifth embodiment is unlocked by operating the key operated locking means 3d. When the key 32d is rotated to an unlocked position as shown in FIG. 27. The hemi-cylinder 34d no longer support the bottom of the tongue 62. The tongue 62 can move downwardly. The spiral spring 64 drives the driving bar 67 push against the moving block 60. The inclined surface 611 of the moving block 60 interact with the inclined surface 621 of the tongue 62 to push the tongue 62 moves downwardly. The sliding element 66 is forced to move to the branch track 652 of the track 65 and thereby moves out of the frame 41. The spring 415d rejects the stop 22 upwardly and the shorter arm 21 of the shackle 2 is removed from the receptacle 16.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

1. A padlock comprising:
a lock body having a first chamber and a second chamber therein, said lock body having a receptacle thereon and a hole communicable to said first chamber;
a shackle having:
a longer arm slidably received in said first chamber through said hole of said lock body, said longer arm having a stop at an end thereof, and
a shorter arm engagable with said receptacle of said block;
a private locking means formed in said first chamber, said private locking means comprising:
a frame having a sliding space therein, said frame having a first opening on top thereof for receiving said end and said stop of said longer arm in said sliding space; and
a mechanism for controlling movements of said frame, said frame being movable between said mechanism and said hole of said lock body; and
a general locking means installed in said second chamber for controlling movements of said end and said stop of sad longer arm.

2. The padlock as claimed in claim 1 wherein said general locking means is a key operated locking means and said private locking means is a combination locking means.

3. The padlock as claimed in claim 1 wherein said general locking means comprising:
a ball;
a first block comprising:
a horizontal beam having an engaging protrusion thereon; and
a vertical beam extended from an end of said horizontal beam, said vertical beam having a hook at an end thereof;
at least one restoring spring engaged with said vertical beam of said first block;
a second block comprising:
a block body having a depression therein for receiving said ball;
a first rod extended from said block body, said first rod having two teeth thereon engagable with said hook of said vertical beam;
a guiding rod extended from said block body, said guiding rod being engagable with a guiding channel of said lock body; and
a compress spring engaged with a bottom of said block body.

4. The padlock as claimed in claim 1 wherein said general locking means comprising:
a moving block having a recess with an inclined surface at bottom thereof;
a driving bar having a sliding channel therein, said driving bar being engaged to driving said moving block;
a sliding element having a cylinder thereon, said sliding element being slidably received in said sliding channel of said driving bar;
a sliding track formed in said lock body, said sliding track having a main track and a branch track extended from middle of said main track; and
a spiral spring engaged with said driving bar; wherein said cylinder of said sliding element is slidably received in said sliding track.

5. The padlock as claimed in claim 1 further comprising a spring located between said stop and an inner bottom of said frame.

6. The padlock as claimed in claim 1 wherein said lock body comprises a front cover and a back cover engaged with said front cover.

7. The padlock as claimed in claim 2 wherein said key operated locking means comprises: a body having a rotor received therein and a driving rod extended from said rotor, said rotor having a keyhole at a bottom end thereof for being engaged with a key, said driving rod having a slot therein, and an engaging element having one end slidably received in said slot, wherein the other end of said engaging element can be rotated by said key through a second opening of said frame to a position between a top of said frame and said stop to block movements of said stop.

8. The padlock as claimed in claim 2 wherein said key operated locking means comprises: a body having a rotor received therein and a driving rod extended from said rotor, said rotor having a keyhole at a bottom end thereof for being engaged with a key, said driving rod having a slot therein, and an engaging element having one end pivotally connected in said slot, wherein the other end of said engaging element can be rotated by said key through a second opening of said frame to a position between an inner top of said frame and said stop to block movements of said stop within said sliding space.

9. The padlock as claimed in claim 2 wherein said frame of said private locking means further comprising a spring plate mounted therein, said spring plate having two bends at upper and lower portion thereof and a swelling between said two bends.

10. The padlock as claimed in claim 3 wherein said general locking means further comprising a key operated locking means comprising a body having a rotor received therein and a hemi-cylinder extended from said rotor, said rotor having a keyhole at a bottom end thereof for being engaged with a key, said hemi-cylinder being engaged with said engaging protrusion of said horizontal beam of said first block.

11. The padlock as claimed in claim 4 wherein said mechanism of said combination locking means comprises a stem connected to said frame and plural number wheels rotatably mounted around said stem for controlling vertical movement of said frame.

12. The padlock as claimed in claim 4 wherein said general locking means further comprising:
a tongue having an inclined surface engagable with said inclined surface of said recess of said moving block, said tongue having a room therein;
a lever mounted in said lock body; and
a spring installed with one end against a top surface of said room of said tongue and with another end against said lever.

13. The padlock as claimed in claim 10 wherein said general locking means further comprising a key operated locking means comprising a body having a rotor received therein and a hemi-cylinder extended from said rotor, said rotor having a keyhole at a bottom end thereof for being engaged with a key, said hemi-cylinder being engaged with said tongue.
